(19) United States
(12) Patent Application Publication
(10) Pub. No.: US 2007/0139307 A1
(43) Pub. Date: Jun. 21, 2007

(54) Apparatus and method for driving display panel

(76) Inventor: Jae-Young Yeo, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/599,540

(22) Filed: Nov. 14, 2006

(30) Foreign Application Priority Data
Dec. 21, 2005 (KR) 10-2005-0126894

(51) Int. Cl. G09G 3/28

(52) U.S. Cl. 345/68

(57) ABSTRACT

An apparatus for driving a display panel that applies a power source having at least one level to each of a plurality of electrodes is disclosed. The electrodes are divided into at least two groups and so as to reduce the instantaneous change in current when the electrodes are driven, the at least two groups are not driven at the same time.

### CROSS-REFERENCE TO RELATED APPLICATIONS

This application claims the benefit of Korean Patent Application No. 10-2005-0126894, filed on Dec. 21, 2005, in the Korean Intellectual Property Office, the disclosure of which is incorporated herein in its entirety by reference.

### BACKGROUND

1. Field of the Invention

The present invention relates to an apparatus and method for driving a display panel, and more particularly, to an apparatus and method for driving a display panel that is configured to display an image by a repetitive discharge during a short time using an electrical energy having a high voltage and frequency.

2. Description of the Related Art

Plasma display panels (PDPs) can be easily manufactured in a large size and thus are widely used as flat-panel displays. The PDP displays an image using a discharge phenomenon. Generally, the PDPs can be classified into a DC PDP and an AC PDP according to the types of their driving signals. Since the DC PDP is disadvantageous because of its long discharge delay, the AC PDP is more actively developed.

A typical example of the AC PDP is a three-electrode surface discharge AC PDP that is driven by an AC voltage applied through three electrodes. The three-electrode surface discharge AC PDP includes a plurality of stacked plates. The three-electrode surface discharge AC PDP is advantageous over a cathode ray tube (CRT) in terms of space efficiency because it is thinner and lighter than the CRT while providing a wider screen than that of the CRT.

A three-electrode surface discharge PDP and an apparatus and method for driving the same are disclosed in U.S. Pat. No. 6,744,218 entitled “Method of driving a plasma display panel in which the width of display sustain pulse varies” applied by the present applicant, which is incorporated herein by reference.

A PDP includes a plurality of display cells positioned nearby locations where sustain electrodes and address electrodes cross each other. Each of the plurality of display cells includes three discharge cells (red, green, and blue), and displays gradation of an image is achieved by controlling a discharge state of the discharge cells.

A frame applied to the PDP constitutes eight sub fields each having a different quantity of light emission and is used to display 256 gradations of the PDP. That is, a frame period (16.67 ms) corresponding to 1/60 second comprises the eight sub fields to display the image as 256 gradations. Each of the eight sub fields includes a reset period, an address period, and a sustain discharge period to drive the PDP.

As a unit light of the PDP increases, a discharge sustain voltage increases, and a frequency increases to increase brightness of the PDP. A voltage having a high voltage and frequency component is applied to each of the electrodes lines to drive the PDP. To this end, switching must be made by a switching element.

Two switching elements are controlled to apply a power to each of electrode lines to apply the power of two levels to a panel capacitor via an electrode line. A single signal can be applied to all Y electrode lines during a specific period according to a method of driving the PDP. The switching elements connected to all Y electrode lines in the specific period can be simultaneously turned on and off.

In this case, a current abruptly changes in all Y electrode lines, causing the emission of an electromagnetic interference (EMI).

### SUMMARY OF CERTAIN INVENTIVE ASPECTS

The present invention provides an apparatus and method for driving a display panel that divide electrode lines to which a single signal is applied into at least two groups, differentiate timing to which the single signal is applied in each of the groups, and reduce the emission of an electromagnetic interference (EMI) due to an abrupt change of a current.

One embodiment is an apparatus configured to drive a display panel by applying at least one of a plurality of voltages to each of a plurality of electrodes. The apparatus includes a plurality of first control switches configured to control connections between a first power source and each of the electrodes, and a plurality of second control switches configured to control connections between each of the electrodes and a second power source. The apparatus is configured to apply a signal that opens the plurality of first control switches and closes the plurality of second control switches to switches for substantially all of the electrodes, the electrodes being divided into at least two groups, and times when the first control switches are opened are differentiated according to the at least two groups and times when the second control switches are closed are differentiated according to the at least two groups.

Another embodiment is an apparatus for driving a display panel in which discharge cells are formed substantially in regions where X electrodes and Y electrodes cross address electrodes, and the apparatus is configured to apply a plurality of voltages to each of the Y electrodes to drive the display panel. The apparatus includes a plurality of first control switches configured to control connections between a first power source and each of the Y electrodes, and a plurality of second control switches configured to control connections between each of the Y electrodes and a second power source, where the apparatus is configured to apply a signal that opens the plurality of first control switches and closes the plurality of second control switches to switches for substantially all of the Y electrodes, the Y electrodes being divided into at least two groups, and times when the first control switches are opened are differentiated according to the at least two groups and times when the second control switches are closed are differentiated according to the at least two groups.

Another embodiment is a method of driving a display panel including a plurality of electrodes, a plurality first control switches configured to control connections between a first power source and each of the electrodes, and a plurality of second control switches configured to control connections between each of the electrodes and a second power source. The method includes applying at least one of a plurality of voltages to each of the plurality of electrodes, the electrodes being divided into at least two groups, where a signal that opens the first control switches and closes the second control switches is applied to substantially all the electrodes and times when the first control switches are opened are differentiated according to the groups, and times when the second control switches are closed are differentiated according to the groups.

### BRIEF DESCRIPTION OF THE DRAWINGS

The above and other features and advantages of the present invention will become more apparent by describing in detail embodiments thereof with reference to the attached drawings in which:

FIG. 1 is a perspective view illustrating the structure of a 3-D surface discharge type PDP according to an embodiment;

FIG. 2 is a block diagram of an apparatus configured to drive the 3-D surface discharge type PDP illustrated in FIG. 1;

FIG. 3 is a circuit diagram of a Y driver of the apparatus illustrated in FIG. 2;

FIG. 4 is a timing diagram for explaining a method of dividing a frame of a PDP into a plurality of sub-fields and driving the PDP;

FIG. 5 illustrates a plurality of Y electrodes which are sequentially divided into two groups;

FIG. 6 is a timing diagram of driving signals output by the Y driver illustrated in FIG. 2 with regard to the PDP illustrated in FIG. 5 according to an embodiment;

FIG. 7 illustrates a plurality of Y electrodes which are divided into a group of odd Y electrodes and a group of even Y electrodes; and

FIG. 8 is a timing diagram of driving signals output by the Y driver illustrated in FIG. 2 with regard to the PDP illustrated in FIG. 7 according to another embodiment of the present invention.

### DETAILED DESCRIPTION OF CERTAIN INVENTIVE EMBODIMENTS

Certain embodiments will now be described more fully with reference to the accompanying drawings.

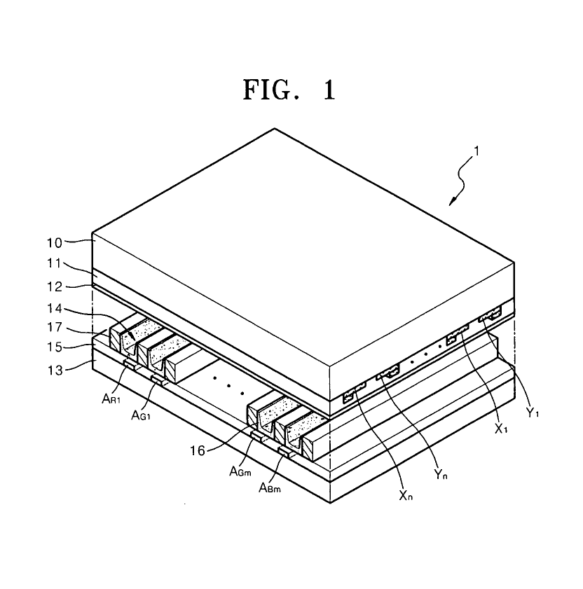

FIG. 1 is a perspective view illustrating the structure of a 3-D surface discharge type PDP 1 according to an embodiment.

Referring to FIG. 1, the 3-D surface discharge type PDP 1 includes a first glass substrate 10, and a second glass substrate 13. Address electrodes A_{R1} . . . , A_{Rm}, first and second dielectric layers 11 and 15, Y electrodes Y₁, . . . , Yₙ, X electrodes X₁, . . . , Xₙ, a phosphor layer 16, barrier ribs 17, and a protective layer (e.g., a magnesium oxide (MgO) layer) 12 disposed between the first and second glass substrates 10 and 13.

The address electrodes A_{R1}, . . . , A_{Rm} are formed on the second glass substrate 13 in a predetermined pattern. The bottom dielectric layer 15 is formed to substantially cover the address electrodes A_{R1}, . . . , A_{Rm}. The barrier ribs 17 are formed on the bottom dielectric layer 15 in parallel to the address electrodes A_{R1}, . . . , A_{Rm}. The barrier ribs 17 define a discharge region of each of the discharge cells 14, and substantially prevent cross talk between the discharge cells 14. The phosphor layer 16 is formed between the bottom dielectric layer 15 and the barrier ribs 17.

The X electrodes X₁, . . . , Xₙ and the Y electrodes Y₁, . . . , Yₙ are formed on the first glass substrate 10 in a predetermined pattern and are perpendicular to the address electrodes A_{R1}, . . . , A_{Rm}. Each of the X electrodes X₁, . . . , Xₙ and the Y electrodes Y₁, . . . , Yₙ includes a transparent conductive electrode such as indium tin oxide (ITO) and a metal electrode for enhancing conductivity. The X electrodes X₁, . . . , Xₙ, the Y electrodes Y₁, . . . , Yₙ, and the address electrodes A_{R1}, . . . , A_{Rm} serve as sustain electrodes, scan electrodes, and address electrodes, respectively, in the discharge cells 14.

The Y electrodes Y₁, . . . , Yₙ serve as the scan electrodes to which a scan pulse is sequentially applied to select a discharge cell to be displayed from the discharge cells 14.

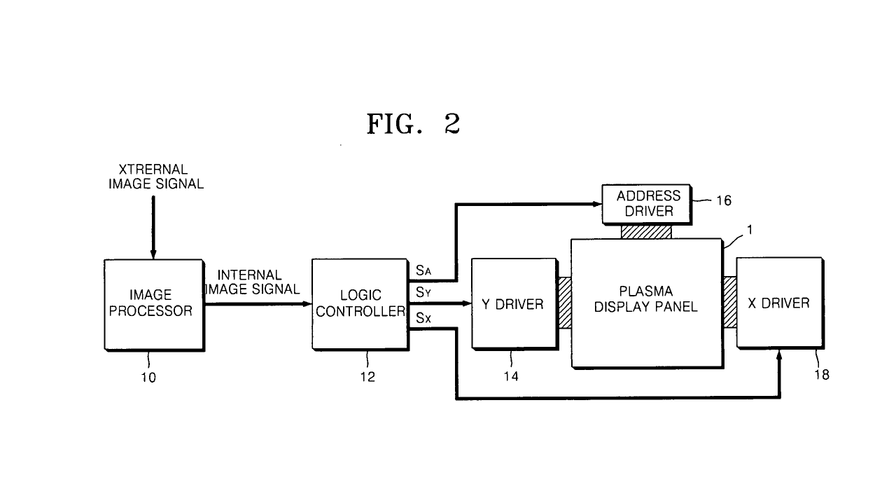

FIG. 2 is a block diagram of an apparatus 20 for driving the 3-D surface discharge type PDP 1 illustrated in FIG. 1.

Referring to FIG. 2, the apparatus includes an image processor 10, a logic controller 12, an address driver 16, an X driver 18, and a Y driver 14. The image processor 10 converts an external analog image signal into a digital signal, and generates an internal image signal. The internal image signal includes red (R), green (G), and blue (B) image data, a clock signal, and vertical and horizontal synchronization signals each having 8 bits.

The address driver 16 receives an address signal S_{A} from the logic controller 12 and applies a display data signal to address electrodes. The X driver 18 receives an X driver control signal S_{X} from the logic controller 12, and applies it to X electrodes. The Y driver 14 receives a Y driver control signal S_{Y} from the logic controller 12 and applies it to Y electrodes.

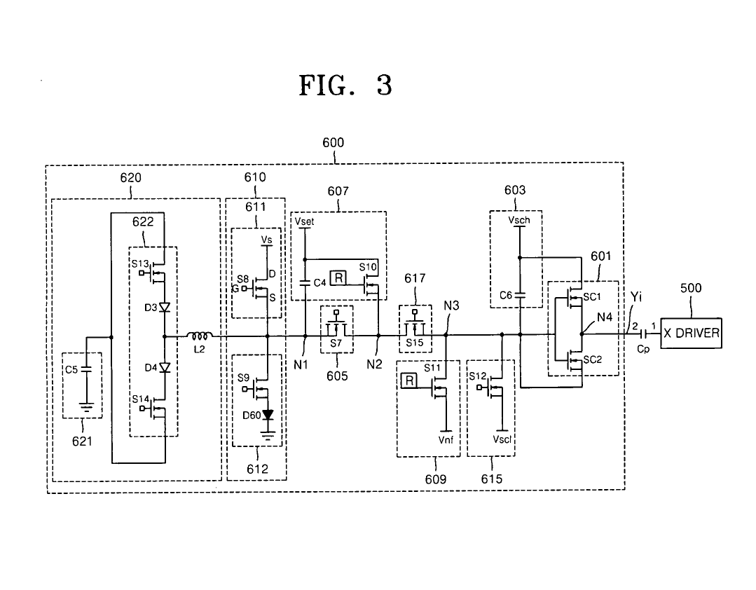

FIG. 3 is a circuit diagram of the Y driver of the apparatus for driving the 3-D surface discharge type PDP illustrated in FIG. 2. One or more of the circuits of FIG. 3 are used to drive the Y electrodes of the PDP. In embodiments where more than one Y electrode is driven by a single circuit, a switching network is used to multiplex the Y electrode signals to the correct Y electrode.

Referring to FIG. 3, the apparatus includes a sustain pulse applying circuit 610, a first switching unit 605, a second switching unit 617, a third voltage applying unit 607, a fourth voltage applying unit 609, a scan switching unit 601, a fifth voltage applying unit 603, a sixth voltage applying unit 615, and an energy recovery circuit 620.

The sustain pulse applying circuit 610 includes a first voltage applying unit 611 that outputs a first voltage Vs to a first node N1 to output driving signals to Y electrodes (i.e., a second terminal of a panel capacitor Cp) and a ground voltage applying unit 612 that outputs a ground voltage Vg to the first node N1.

The first switching unit 605 includes a seventh switching element S7 having one terminal connected to the first node N1 and another terminal connected to a second node N2. The second switching unit 617 includes a fifteenth switching element S15 having one end connected to the second node N2 and the other end connected to a third node N3.

The third voltage applying unit 607 is connected between the first node N1 and the second node N2 and steps up the signal voltage from the first voltage Vs to a third voltage Vset and outputs the stepped up voltage to the second node N2. The fourth voltage applying unit 609 is connected to the third node N3 and changes the voltage at the third node N3 to a fourth voltage Vnf. The scan switching unit 601 includes first and second scan switching elements SC1 and SC2 serially connected to each other, and a fourth node N4 located between the first and second scan switching elements SC1 and SC2 and connected to the Y electrodes (i.e., the second terminal of the panel capacitor Cp). The Y electrodes are divided into a plurality of blocks. The scan switching unit 601 can include a plurality of scan ICs so that each of the plurality of scan ICs can be connected to each of the plurality of blocks.

The fifth voltage applying unit 603 includes a fifth voltage (Vsch) source and is connected to the first scan switching element SC1 to output the fifth voltage Vsch to the first scan switching element SC1. The sixth voltage applying unit 615 is connected to the third node N3 and the second scan switching element SC2 is connected to output voltage Vscl.

The energy recovery circuit 620 charges the panel capacitor Cp with electric charge or recovers and stores electric charge from the panel capacitor Cp.

The first voltage applying unit 611 includes an eighth switching element S8 having one terminal connected to the first voltage source (Vs) and the other terminal connected to the first node N1. The ground voltage applying unit 612 includes a ninth switching element S9 having one terminal connected to diode D60 which is connected to the ground (Vg) and the other terminal connected to the first node N1. The sustain pulse applying circuit 610 alternatively turns on the eighth and ninth switching elements S8 and S9 to generate sustain pulses.

The eighth and ninth switching elements S8 and S9 can be field effect transistors (FET) each having a drain terminal, a gate terminal, and a source terminal. The drain terminal of the eighth switching element can be connected to a power source Vs, the gate terminal can be connected to a driver (not shown), and the source terminal can be connected to the first node N1.

The third voltage applying unit 607 includes a fourth capacitor C4 having one terminal connected to the first node N1 and the other terminal connected to a third voltage source Vset, and a tenth switching element S10 connected between the third voltage source Vset and the second node N2.

During one driving period, the seventh switching element S7 of the first switching unit 605 is turned off, the fifteenth switching element S15 of the second switching unit 617 is turned on, and the eighth switching element S8 of the first voltage applying unit 611 and the tenth switching element S110 of the third voltage applying unit 607 are turned on. Accordingly, the voltage of the third node N3 gradually increases by the third voltage Vset from the fifth voltage Vsch and thus the highest voltage (Vset+Vsch) is output to the Y electrodes via the fourth node N4.

The fourth voltage applying unit 609 includes an eleventh switching element S11 having one terminal connected to the third node N3 and the other terminal connected to a fourth voltage source Vnf. During one driving period the eighth switching element S8 of the first voltage applying unit 611, the seventh switching element S7 of the first switching unit 605, the fifteenth switching element S15 of the second switching unit 617, and the eleventh switching element S11 of the fourth voltage applying unit 609 are turned on. Accordingly, the first voltage Vs gradually decreases to the fourth voltage Vnf from the first voltage Vs and the gradually-decreased voltage is outputted to the third node N3.

When the first scan switching element SC1 of the scan switching unit 601 is turned on and the second scan switching element SC2 is turned off in the Y electrodes, the fifth voltage Vsch is not applied by the scan IC 601. A current of the scan IC 601 abruptly changes in the Y electrodes, causing an increase in the emission of an electromagnetic interference (EMI).

Therefore, the Y electrodes are divided into at least two groups, and times when the first scan switching element SC1 is opened and the second scan switching element SC2 is closed are differentiated, thereby reducing the emission of the EMI due to the abrupt change in the current.

The sixth voltage applying unit 615 includes a twelfth switching element S12 connected between the third node N3 and a sixth voltage source Vscl. The twelfth switching element S12 is turned on to output the sixth voltage Vscl to the third node N3.

When the first scan switching element SC1 of the scan switching unit 601 is turned on and the second scan switching element SC2 is turned off, the fifth voltage Vsch is output through the fourth node N4 to the Y electrodes (the second terminal of the panel capacitor Cp). On the contrary, when the first scan switching element SC1 is turned off and the second scan switching element SC2 is turned on, the voltages output to the third node N3 (i.e., the first voltage Vs, the ground voltage Vg, the fourth voltage Vnf, and the sixth voltage Vscl) are outputted through the fourth node N4 to the Y electrodes (the second terminal of the panel capacitor Cp).

The energy recovery circuit 620 includes an energy storage unit 621, an energy recovery switching unit 622, and an inductor L2. The energy storage unit 621 recovers electric charge from the panel capacitor Cp and charges the panel capacitor Cp with electric charge. The energy recovery switching unit 622 is connected to the energy storage unit 621, and controls charge of the panel capacitor Cp with electric charge by the energy storage unit 621 and recovery of electric charge from the panel capacitor Cp by the energy storage unit 621. The inductor L2 has one terminal connected to the energy recovery switching unit 622 and the other terminal connected to the first node N1.

The energy storage unit 621 may include a fifth capacitor C5 for storing electric charge recovered from the panel capacitor Cp. The energy recovery switching unit 622 may include thirteenth and fourteenth switching elements S13 and S14 having one terminal connected to the energy storage unit 621 and the other end connected to the inductor L2. Third and fourth diodes D3 and D4 may be connected between the thirteenth and fourteenth switching elements S13 and S14 in opposite directions.

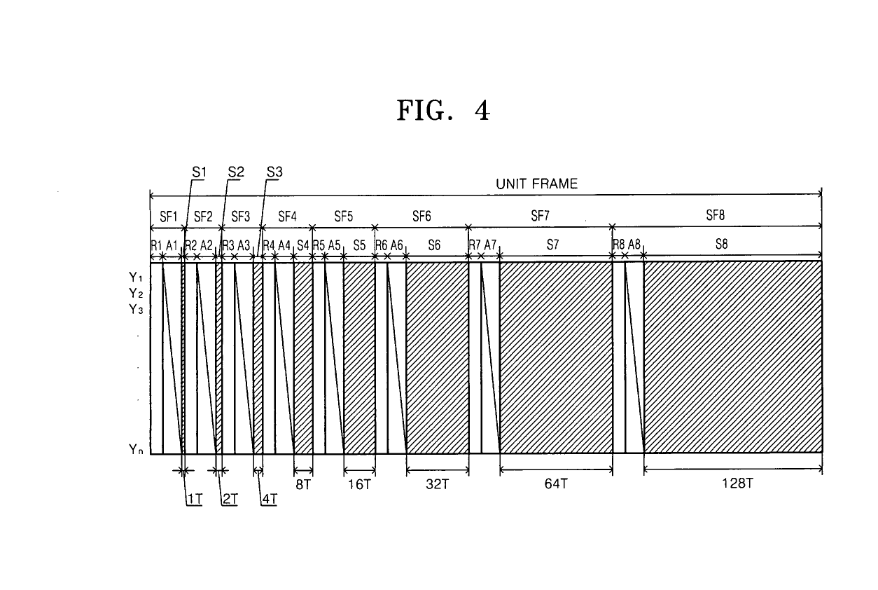

FIG. 4 is a timing diagram for explaining a method of dividing a unit frame of a PDP into a plurality of sub-fields for driving the PDP.

Referring to FIG. 4, the unit frame is divided into eight sub-fields SF1 through SF8 to achieve time division gradation display, and each of the sub-fields SF1 through SF8 is divided into a reset period R1 through R8, an address period A1 through A8, and a sustain discharge period S1 through S8, respectively.

The brightness of the PDP is proportional to the duration of the sustain discharge period S1 through S8 in the unit frame. The maximum duration of the sustain discharge period S1 through S8 in the unit frame is 255T (T denotes time). A time corresponding to a factor of 2ⁿ is established in the sustain discharge period Sn during the nth sub field SFn. Therefore, 256 gradations including 0 gradation that is displays in no sub field can be displayed.

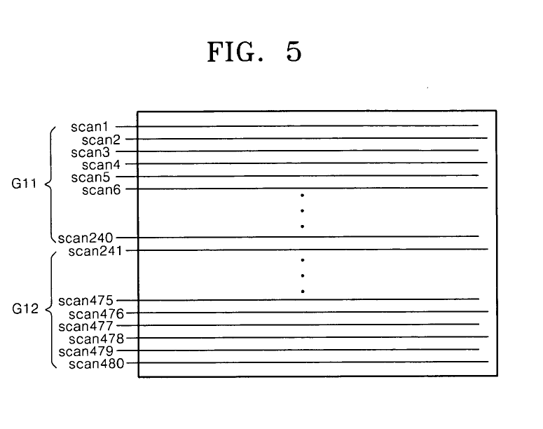

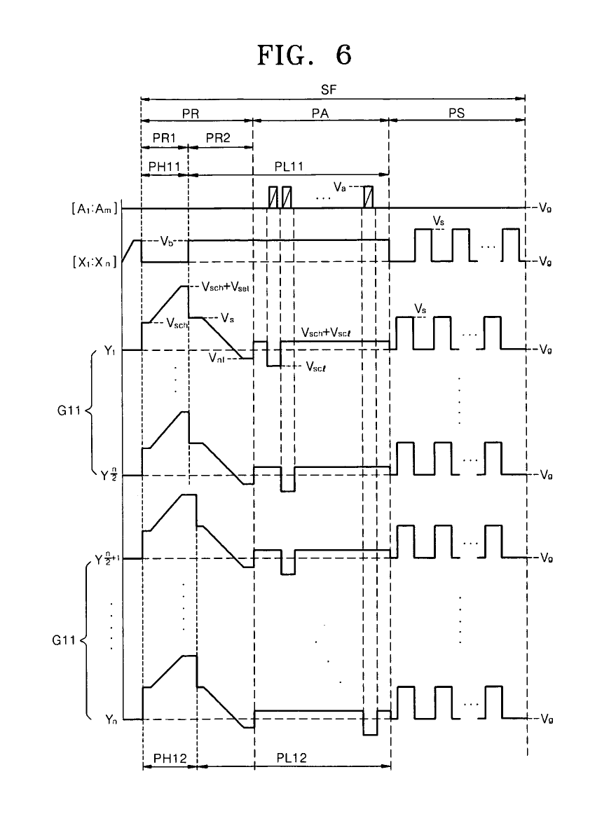

FIG. 5 illustrates the Y electrodes which are sequentially divided into two groups. FIG. 6 is a timing diagram of the driving signals output by each of the drivers illustrated in FIG. 2 for the PDP illustrated in FIG. 5, according to one embodiment.

Referring to FIG. 6, a unit frame for driving the PDP is divided into eight sub-fields according to each of gradation weights to display a time division gradation, and each of the sub-fields SF1 through SF8 is divided into a reset period PR, an address period PA, and a sustain discharge period PS.

The reset period PR includes a first reset period PR1 and a second reset period PR2, during which the discharge cells are initialized.

In the first reset period PR1, a voltage having a rising ramp pulse waveform that has a substantially constant slope from a first level Vsch to a third level Vsch+Vset is applied to Y electrodes. X electrodes and address electrodes are biased to a ground level Vg.

In the second reset period PR2, a voltage having a falling ramp pulse waveform that has a substantially constant slope from a fourth level Vs to a fifth level Vnf is applied to the Y electrodes. The X electrodes are biased with a bias voltage Vb and perform a reset discharge, thereby initializing all the discharge cells.

In a starting point of the second reset period PR2, a signal that opens a first control switch and closes a second control switch is applied to all the Y electrodes. The first control switch may be a switch such as the first scan switching element SC1 illustrated in FIG. 3, and the second control switch may be a switch such as the second scan switching element SC2 illustrated in FIG. 3.

Referring to FIG. 5, the Y electrodes are divided into a first group G11 and a second group G12 from one end of the PDP to another end of the PDP. When the number of the Y electrodes is an even number, the first and second groups G11 and G12 may have the same number of the Y electrodes.

A timing when the first control switch SC1 opens to and the second control switch SC2 closes to the Y electrodes of the second group G12 alternates a timing when the first control switch SC1 opens to and the second control switch closes to the Y electrodes of the first group G11.

For example, a switch control timing in the second group G12 is followed by a switch control timing in the first group G11 as illustrated in FIG. 6. Therefore, a current sequentially changes in all the Y electrodes so that a current change is reduced at a point, thereby reducing the emission of an EMI. That is, at any one point during the address period PA only a portion of the Y electrodes are being driven.

In the address period PA, a scan pulse is sequentially applied to Y electrodes, and a display data signal is applied to A electrodes in accordance with the scan pulse, thereby performing an address discharge, so that discharge cells to perform a sustain discharge during the sustain period PS are selected.

During the address period PA, when all the Y electrodes are biased with a scan high voltage Vsch+Vscl, a scan pulse having a scan low voltage Vscl lower than the scan high voltage Vsch+Vscl is sequentially applied to all the Y electrodes. A data pulse having a positive address voltage Va is applied to the display data signal in accordance with the scan pulse.

During the sustain period PS, a sustain pulse is alternately applied to the X electrodes and the Y electrodes, so that the sustain discharge is performed, thereby displaying brightness according to the gradation weights allocated to each of the sub fields. The sustain pulse has alternately a sustain discharge voltage Vs and the ground voltage Vg.

Driving signals other than the driving signals illustrated in FIG. 6 can be output from each of the drivers illustrated in FIG. 2.

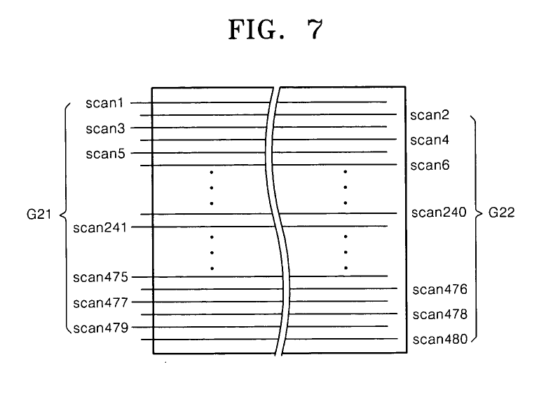

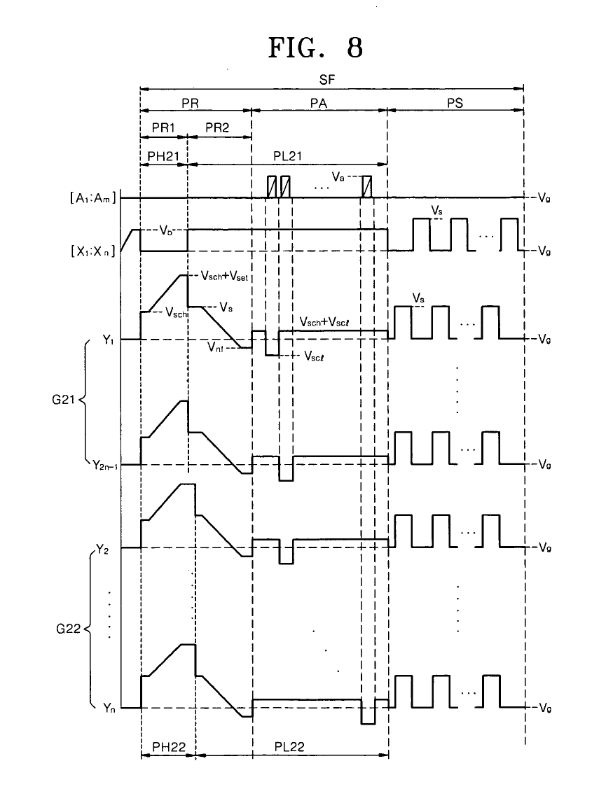

FIG. 7 illustrates the Y electrodes which are divided into two groups of odd Y electrodes and even Y electrodes. FIG. 8 is a timing diagram of the driving signals output by each of the drivers illustrated in FIG. 2 with regard to the PDP illustrated in FIG. 7 according to another embodiment.

Referring to FIG. 8, power sources having at least one level are applied to each of a plurality of electrodes. At a starting point of a second reset period PR2, a signal that opens a first control switch SC1 and closes a second control switch SC2 is applied to all the Y electrodes. The Y electrodes are divided into at least two groups G21 and G22, and times where the first control switch SC1 opens and the second control switch SC2 closes are differentiated according to the two groups G21 and G22.

The current embodiment is the same as a previous embodiment illustrated in FIGS. 5 and 6 except a method of dividing the Y electrodes into two groups. Therefore, a redundant description will not be repeated.

Referring to FIG. 7, the odd Y electrodes are the first group G21, and the even Y electrodes are the second group G22. When the number of the Y electrodes is an even number, the first and second groups G21 and G22 may have the same number of the Y electrodes. Also, the difference between the numbers of the first and second groups G21 and G22 may be minimized.

Referring to FIG. 8, during the second reset period PR2, a switch control timing in the second group G22 is followed by a switch control timing in the first group G21. Therefore, the current sequentially changes in all the Y electrodes so that a current change is reduced at a point, thereby reducing the emission of an EMI.

During the address period PA, when all the Y electrodes are biased with a scan high voltage Vsch+Vscl, a scan pulse having a scan low voltage Vscl, lower than the scan high voltage Vsch+Vscl, is sequentially applied to the odd Y electrodes, and a scan pulse having a scan low voltage Vscl lower than the scan high voltage Vsch+Vscl is sequentially applied to the even Y electrodes. A data pulse having a positive address voltage Va is applied to the display data signal in accordance with a scan pulse.

According to apparatus and method embodiments for driving a PDP, electrodes to which a signal is applied are divided into at least two groups, and times when the signal is applied are differentiated according to the groups, thereby reducing the emission of the EMI due to an abrupt change in a current.

While aspects have been particularly shown and described with reference to certain embodiments, it will be understood by those of ordinary skill in the art that various changes in form and details may be made therein without departing from the spirit and scope of the present invention.

What is claimed is:

1. An apparatus configured to drive a display panel by applying at least one of a plurality of voltages to each of a plurality of electrodes, the apparatus comprising:
a plurality of first control switches configured to control connections between a first power source and each of the electrodes; and
a plurality of second control switches configured to control connections between each of the electrodes and a second power source,
wherein the apparatus is configured to apply a signal that opens the plurality of first control switches and closes the plurality of second control switches to switches for substantially all of the electrodes, the electrodes being divided into at least two groups, and times when the first control switches are opened are differentiated according to the at least two groups and times when the second control switches are closed are differentiated according to the at least two groups.

2. The apparatus of claim 1, wherein the electrodes are divided into a first group and a second group, and a time when the first control switches are opened and the second control switches are closed to the electrodes of the second group is followed by another time when the first control switches are opened and the second control switches are closed to the electrodes of the first group.

3. The apparatus of claim 2, wherein the electrodes extend in a first direction of the display panel, the first group comprising odd electrodes extending substantially from one end of the display panel to another end of the display panel, and the second group comprising even electrodes.

4. The apparatus of claim 1, wherein the electrodes extend in a first direction of the display panel, and are divided into two or more groups sequentially from substantially one end of the display panel to substantially another end of the display panel.

5. The apparatus of claim 1, wherein the electrodes are divided substantially equally into the groups.

6. The apparatus of claim 1, wherein the first power source supplies a higher voltage than the second power source.

7. The apparatus of claim 1, wherein discharge cells are formed substantially in regions where X electrodes and Y electrodes cross address electrodes.

8. An apparatus for driving a display panel in which discharge cells are formed substantially in regions where X electrodes and Y electrodes cross address electrodes, and the apparatus is configured to apply a plurality of voltages to each of the Y electrodes to drive the display panel, the apparatus comprising:
a plurality of first control switches configured to control connections between a first power source and each of the Y electrodes; and
a plurality of second control switches configured to control connections between each of the Y electrodes and a second power source,
wherein the apparatus is configured to apply a signal that opens the plurality of first control switches and closes the plurality of second control switches to switches for substantially all of the Y electrodes, the Y electrodes being divided into at least two groups, and times when the first control switches are opened are differentiated according to the at least two groups and times when the second control switches are closed are differentiated according to the at least two groups.

9. The apparatus of claim 8, wherein a unit frame comprises a plurality of sub fields each having a gradation weight to achieve time division gradation display, each of the sub fields comprising a reset period, an address period, and a sustain discharge period, and
the apparatus configured to, during the address period, sequentially apply a scan pulse to the Y electrodes from substantially an end of the display panel to substantially another end of the display panel, and to apply a data pulse to address electrodes of one or more discharge cells to be displayed, wherein at least one discharge cell is selected from the discharge cells.

10. The apparatus of claim 9, wherein the reset period comprises a first reset period during which a voltage having a rising ramp pulse waveform that has a substantially constant slope and increases from a first level to a third level is applied to the Y electrodes, and a second reset period during which a voltage having a falling ramp pulse waveform that has a substantially constant slope and decreases from a fourth level to a fifth level is applied to the Y electrodes.

11. The apparatus of claim 10, wherein the apparatus is further configured to apply a signal that opens the first control switches and closes the second control switches to substantially all the Y electrodes at a starting point of the second reset period.

12. The apparatus of claim 11, wherein the Y electrodes are divided into a first group and a second group, and a time when the first control switches are opened and the second control switches are closed to the Y electrodes of the second group is followed by another time when the first control switches are opened and the second control switches are closed to the Y electrodes of the first group.

13. The apparatus of claim 12, wherein the Y electrodes extend in a first direction of the display panel, and are divided into the first and second groups sequentially substantially from one end of the display panel to substantially another end of the display panel.

14. The apparatus of claim 12, wherein the Y electrodes extend in a first direction of the display panel, the odd Y electrodes extending substantially from one end of the display panel to another end of the display panel are included in the first group, and the even Y electrodes are included in the second group.

15. The apparatus of claim 12, wherein the Y electrodes are divided substantially equally into the first and second groups.

16. A method of driving a display panel comprising a plurality of electrodes, a plurality first control switches configured to control connections between a first power source and each of the electrodes, and a plurality of second control switches configured to control connections between each of the electrodes and a second power source, the method comprising:
applying at least one of a plurality of voltages to each of the plurality of electrodes, the electrodes being divided into at least two groups, wherein a signal that opens the first control switches and closes the second control switches is applied to substantially all the electrodes and times when the first control switches are opened are differentiated according to the groups, and times when the second control switches are closed are differentiated according to the groups.

17. The method of claim 16, wherein the electrodes are divided into a first group and a second group, and a time when the first control switches are opened and the second control switches are closed to the electrodes of the second group is followed by another time when the first control switches are opened and the second control switches are closed to the electrodes of the first group.

18. The method of claim 17, wherein the electrodes extend in a first direction of the display panel, the first group comprising odd electrodes extending substantially from one end of the display panel to another end of the display panel, and the second group comprising even electrodes.

19. The method of claim 17, wherein the electrodes extend in a first direction of the display panel, and are divided into the first and second groups sequentially from substantially one end of the display panel to substantially another end of the display panel.

20. The method of claim 16, wherein discharge cells are formed substantially in regions where X electrodes and Y electrodes cross address electrodes.

21. The method of claim 16, wherein discharge cells are formed substantially in regions where the X electrodes and the Y electrodes cross the address electrodes and a signal that opens the first control switches and closes the second control switches is applied to the Y electrodes.

22. The method of claim 21, wherein a unit frame comprises a plurality of sub fields each having a gradation weight to achieve time division gradation display, each of the sub fields comprising a reset period, an address period, and a sustain discharge period, and the method further comprises:
during the address period, sequentially applying a scan pulse to the Y electrodes from substantially an end of the display panel to substantially another end of the display panel; and
applying a data pulse to address electrodes of one or more discharge cells to be displayed, wherein at least one discharge cell is selected from the discharge cells.

23. The method of claim 22, wherein the reset period comprises a first reset period during which a voltage having a rising ramp pulse waveform that has a substantially constant slope and increases from a first level to a third level is applied to the Y electrodes, and a second reset period during which a voltage having a falling ramp pulse waveform that has a substantially constant slope and decreases from a fourth level to a fifth level is applied to the Y electrodes.

24. The method of claim 23, further comprising applying a signal that opens a first control switch and closes a second control switch to substantially all the Y electrodes at a starting point of the second reset period.

25. The method of claim 24, wherein the Y electrodes are divided into a first group and a second group, and a time when the first control switches are opened and the second control switches are closed to the Y electrodes of the second group is followed by another time when the first control switches are opened and the second control switches are closed to the Y electrodes of the first group.

26. The method of claim 16, wherein the Y electrodes are divided substantially equally into the first and second groups.
